(19) United States
(12) Patent Application Publication
(10) Pub. No.: US 2013/0146792 A1
(43) Pub. Date: Jun. 13, 2013

(54) Integral shutter

(71) Applicant: Alex Deyhim, Ithaca, NY (US)

(72) Inventor: Alex Deyhim, Ithaca, NY (US)

(21) Appl. No.: 13/373,985

(22) Filed: Dec. 7, 2011

(51) Int. Cl. G21F 3/00

(52) U.S. Cl. 250/515.1

(57) ABSTRACT

An integral shutter that is for use in several beamline applications. The shutter combines the features and properties of a pink beam photon shutter, a pink beam safety shutter, a pink beam fixed mask and a pink beam collimator. The device is important for synchrotron radiation facility personal safety. These assemblies are needed to guard against accidental positron beam loss during both injection and normal operation. Positron beam loss can result in high-energy radiation being directed into an experimental station.

### CROSS REFERENCE TO RELATED APPLICATIONS

Not applicable

### STATEMENT REGARDING FEDERALLY SPONSORED RESEARCH OR DEVELOPMENT

Not Applicable

### SEQUENCE LISTING OR PROGRAM

Not Applicable

### BACKGROUND OF THE INVENTION

A shutter is for use in beamline apparatus applications. The purpose of a shutter is to shut off any unwanted radiation, rays, particle beams, or waves from a specified area or experimental chamber. The integral shutter combines the important features of several different beamline apparatus' to create a safety shutter that guard against positron beam loss and high-energy radiation escaping the chamber.

### SUMMARY OF THE INVENTION

The integral shutter combines the features of a pink beam photon shutter, a pink beam safety shutter, a pink beam fixed mask and a pink beam collimator. The safety shutter is an important device for synchrotron radiation facility personal safety. These assemblies are needed to guard against accidental positron beam loss during injection and normal operation, which then can result in high-energy radiation being directed down the front end into an experimental station.

The moving assembly is a bonded Glidcop/OFHC copper which prevents the photon beam from traveling down a beamline into an experimental enclosure. When the shutter is closed, two shielding blocks are positioned to stop the synchrotron beam, although either block by itself provides adequate shielding. Redundant switches detect any shutter failure so that a personnel safety interlock system can take appropriate measures to shut the beam off during a fault condition. All shutters are designed in the ‘fail safe’ mode such that, in the event of a power, communication or mechanical system failure, the shifter will come to a closed position and will remain closed. The fixed mask and collimator are positioned between the shutter assemblies.

### BRIEF DESCRIPTION OF DRAWINGS

The invention as described herein with references to subsequent drawings, contains similar reference characters intended to designate like elements throughout the depictions and several views of the depictions. It is understood that in some cases, various aspects and views of the invention may be exaggerated or blown up (enlarged) in order to facilitate a common understanding of the invention and its associated parts.

FIG. 1 is a schematic of the overall integral shutter design with stand.

FIG. 2 is a schematic of the shutter and stand, rotated.

FIG. 3 is a schematic of the shutter without stand.

### DETAILED DESCRIPTION OF INVENTION

Provided herein is a detailed description of one embodiment of the invention. It is to be understood, however, that the present invention may be embodied with various dimensions. Therefore, specific details enclosed herein are not to be interpreted as limiting, but rather as a basis for the claims and as a representative basis for teaching one skilled in the art to employ the present invention in virtually any appropriately detailed system, structure, or manner.

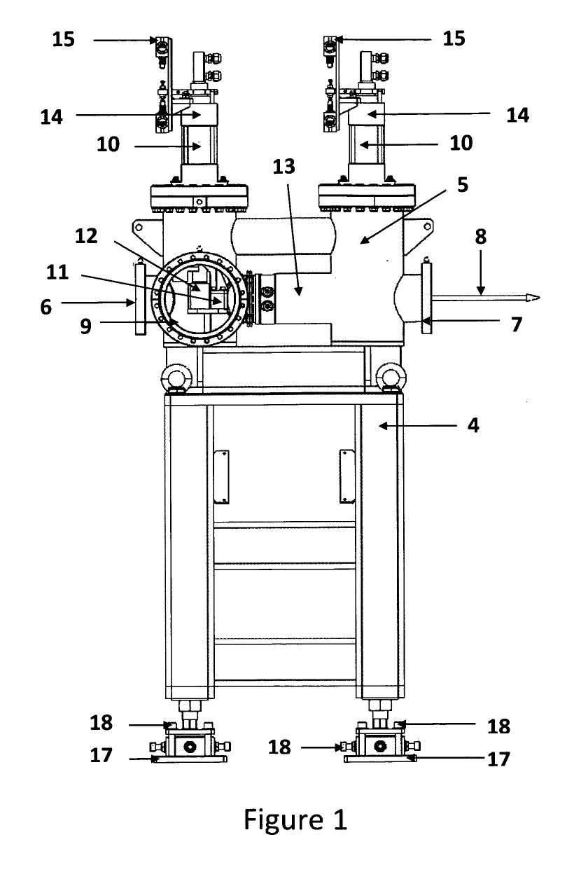

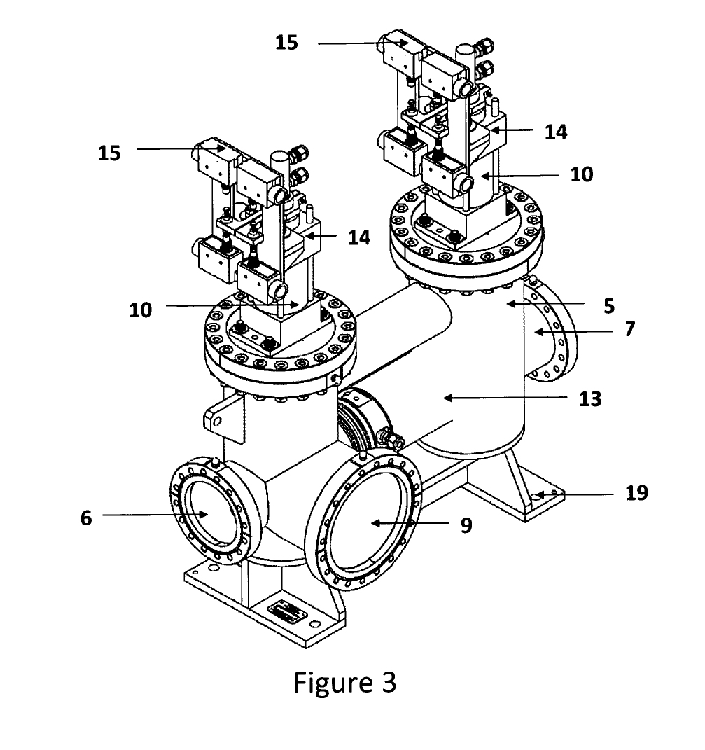

FIG. 1 represents the overall integral shutter design as it is mounted on its stand 4. The integral shutter combines the structures of other standard synchrotron applications to provide important safety precautions for synchrotron radiation facility personal safety. The device combines the features of a pink beam photon shutter, a pink beam safety shutter, a pink beam fixed mask and a pink beam collimator. These assemblies are needed to guard against accidental positron beam loss during injection and normal operation. The chamber 5 comprising the associated components is made of stainless steel. It has an entrance flange 6 and exit flange 7 which run along beamline direction 8. Another port on the chamber is the pumping port 9. The chamber contains a fixed tungsten block which serves as the collimator 13. The moving assembly is a double-redundant remotely actuated pneumatic cylinder set 10, with a moving tungsten block 11 and a moving explosive-bonded Glidcop/OFHC copper block 12 which prevent the photon beam from travelling down the beamline into an experimental enclosure. Also visible in this figure are the pneumatic slides 14 which control the opening and closing of the shutter and the slide position sensor switches 15 which control the position of the slides. These are better seen and further described in FIG. 3.

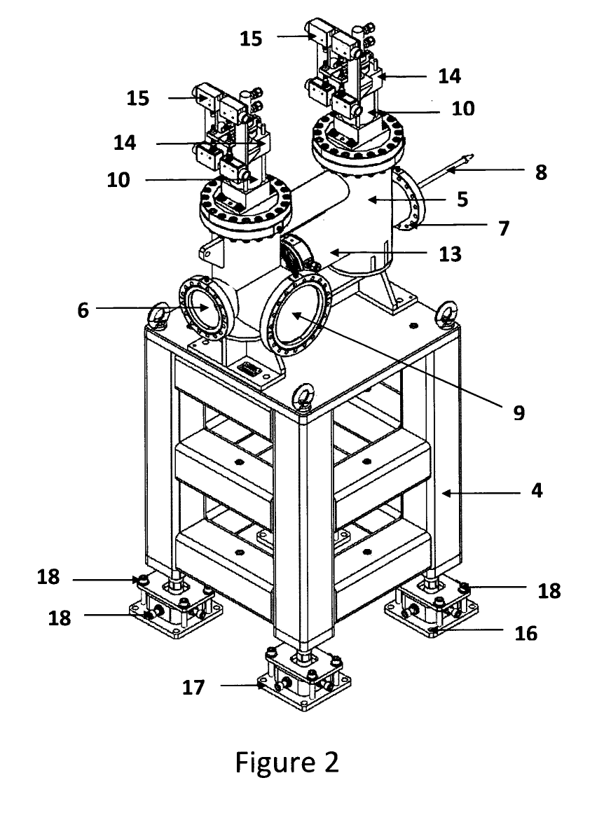

FIG. 2 represents a rotated view of the overall design as it is attached to the stand 4. Visible in this figure are the chamber 5 which comprises the entrance flange 6, exit flange 7, which run along the beamline direction 8, and pumping port 9 on the side. The chamber contains a fixed tungsten block which serves as the collimator 13. A collimator is a device, in this application made of tungsten, which narrows a beam of particles to either cause the direction of motions to become more aligned in a specific direction or to cause the spatial cross section of the beam become smaller in diameter. The moving assembly is a double-redundant remotely actuated pneumatic cylinder set 10. Also visible are the pneumatic slides 14 and slide position sensor switches 15. The stand has feet 17 that have the ability to anchor to the floor with floor mounting holes 16. The adjustment screws 18, eight per foot, give the ability to adjust and lock the parallelism of the table with respect to the floor (pitch and roll) and align the height and transverse position.

FIG. 3 is a schematic of the overall integral shutter design. The chamber 5 comprises the entrance flange 6, exit flange 7, and pumping port 9. The chamber contains a fixed tungsten block which acts as the collimator 13. The moving assembly is a double-redundant remotely actuated pneumatic cylinder set 10, which move the internal moving tungsten block and moving explosive bonded Glidcop/OFHC copper block which prevent the photon beam from travelling down the beamline into an experimental enclosure. The pneumatic slides 14 have slide position sensor switches 15 that control the movement and position of the actuated slides which control the shutter. The shutter has a maximum travel distance of 33 mm. When the shutter is closed, two shielding blocks are positioned to stop the synchrotron beam, although either block by itself provides accurate shielding. Redundant switches detect any shutter failure so that a personnel safety interlock system can take appropriate measures to shut the beam off during a fault condition. The shutters are designed in the ‘fail safe’ mode such that, in the event of a power, communication, or mechanical system failure, the shutter will come to a closed state. The integral shutter has mounting holes 19 to mount to the stand or other level surface.

What is claimed is:

1. An integral shutter comprising:
(a) A chamber;
(b) An entrance flange;
(c) An exit flange;
(d) A pumping port;
(e) Pneumatic slides;
(f) Slide position sensor switches;
(g) A collimator;
(h) Shutters;
(i) A stand.

2. The apparatus of claim 1 wherein said chamber is made of stainless steel.

3. The apparatus of claim 1 wherein said entrance flange is on one end of said chamber, along the beamline.

4. The apparatus of claim 1 wherein said exit flange is at the opposite end of the entrance flange, along the beamline.

5. The apparatus of claim 1 wherein said pumping port is located adjacent to the entrance flange, perpendicular to the beamline.

6. The apparatus of claim 1 wherein said pneumatic slides control the double redundant pneumatic cylinders that move the shutters inside said chamber.

7. The apparatus of claim 6 wherein said pneumatic slides move to a maximum distance of 33 mm.

8. The apparatus of claim 1 wherein said slide position sensor switches are attached to the pneumatic slides of claim 6 and control the position of the slides.

9. The apparatus of claim 6 wherein said pneumatic slides contain tungsten and explosive bonded Glidcop/OFHC copper which prevent the photon beam from travelling down the beamline.

10. The apparatus of claim 1 wherein said collimator is made of tungsten and sits inside said chamber of claim 1.

11. The apparatus of claim 10 wherein said collimator serves to narrow the beam being passed through the chamber.

12. The apparatus of claim 1 wherein said shutters are designed in a ‘fail safe’ mode such that the shutter will come to a closed state in any sort of power, communication or mechanical system failure.

13. The apparatus of claim 12 wherein said shutters use redundant switches to detect any shutter failure.

14. The apparatus of claim 1 wherein said stand is attached to the overall integral shutter using a level surface and mounting holes on the chamber.

15. The apparatus of claim 14 wherein said stand has four feet mounted to the legs of the stand.

16. The apparatus of claim 15 wherein said feet have the ability to be mounted to the floor with floor mounting holes, for added stability.

17. The apparatus of claim 15 wherein said feet have eight adjustment screws each, that provide the ability to adjust and lock parallelism of the table with respect to the floor.

18. The apparatus of claim 17 wherein said adjustment screws also aid in adjustment of height and transvers position of the table surface of the stand.
